(19) United States
(12) Patent Application Publication
(10) Pub. No.: US 2025/0063057 A1
(43) Pub. Date: Feb. 20, 2025

(54) FRAUD DETECTION AND PREVENTION IN VIRTUAL REALITY COLLABORATION

(71) Applicant: International Business Machines Corporation, Armonk, NY (US)

(72) Inventors: Sarbajit K. Rakshit, Kolkata (IN); Jagabondhu Hazra, HBR Layout 5 (IN); Manikandan Padmanaban, Chennai (IN)

(21) Appl. No.: 18/451,167

(22) Filed: Aug. 17, 2023

(51) Int. Cl. H04L 9/40; G06N 5/022; G06V 40/20

(52) U.S. Cl. CPC H04L 63/1425; G06N 5/022; G06V 40/20; H04L 63/1416

(57) ABSTRACT

A virtual reality (VR) collaboration network includes a VR computing system and a fraud detection and prevention system. The VR computing system is configured to generate a VR environment and to generate at least one avatar within the VR environment based on a user profile associated with an authorized human participant. The fraud detection and prevention system is configured to monitor the VR environment and at least one real-time behavior of the at least one avatar, and to identify the at least one avatar as a suspicious avatar operated by an unauthorized human participant different from the authorized human participant in response to the at least one real-time behavior being different from at least one expected behavior of the at least one avatar.

### BACKGROUND

The present disclosure generally relates generally to virtual and augmented reality environments, and more specifically, to methods and systems for fraud detection and prevention in virtual reality collaboration.

Virtual reality (VR) devices create a simulated experience using three-dimensional displays to provide a user with an immersive feel of a virtual world. Applications of virtual reality include entertainment (such as watching movies or playing video games), education (such as medical or other training), and business (such as virtual meetings). Other types of VR-style technology include augmented reality (AR) and mixed reality, sometimes referred to as extended reality (XR).

VR equipment such as VR headsets or multi-projected environments, generate realistic images, sounds, and other sensations that simulate a user's physical presence in a virtual environment. A person using VR equipment can look around the artificial world, move around in it, and interact with virtual features or items. Many VR systems use headsets that include a head-mounted display with a small screen in front of the eyes of a user, but VR systems can utilize specially designed rooms with multiple large screens. VR systems typically incorporate auditory and video feedback but may also allow other types of sensory and force feedback through haptic technology.

VR equipment can be utilized simultaneously by multiple users to establish a collaborative VR environment sometimes referred to as a “metaverse. The VR environment is collective virtual shared space that converges the physical and digital realms. Users can interact with each other and digital objects in real-time so that users can interact with each other and digital elements simultaneously, regardless of their physical location.

### SUMMARY

According to a non-limiting embodiment, a virtual reality (VR) collaboration network includes a VR computing system and a fraud detection and prevention system. The VR computing system is configured to generate a VR environment and to generate at least one avatar within the VR environment based on a user profile associated with an authorized human participant. The fraud detection and prevention system is configured to monitor the VR environment and at least one real-time behavior of the at least one avatar, and to identify the at least one avatar as a suspicious avatar operated by an unauthorized human participant different from the authorized human participant in response to the at least one real-time behavior being different from at least one expected behavior of the at least one avatar.

According to another non-limiting embodiment, a method of performing fraud detection and prevention in a virtual reality (VR) collaboration environment is provided. The method comprises generating a VR environment by a VR computing system, and generating at least one avatar within the VR environment based on a user profile associated with an authorized human participant. The method further includes monitoring, by a fraud detection and prevention system, the VR environment and at least one real-time behavior of the at least one avatar. The method further includes identifying, by the fraud detection and prevention system, the at least one avatar as a suspicious avatar operated by an unauthorized human participant different from the authorized human participant in response to the at least one real-time behavior being different from at least one expected behavior of the at least one avatar.

According to yet another non-limiting embodiment, a computer program product comprising a computer readable storage medium having program instructions embodied therewith to perform fraud detection and prevention in a virtual reality (VR) collaboration environment, the program instructions executable by a processor to cause the processor to perform operations comprising generating a VR environment by a VR computing system, and generating at least one avatar within the VR environment based on a user profile associated with an authorized human participant. The method further includes monitoring, by a fraud detection and prevention system, the VR environment and at least one real-time behavior of the at least one avatar. The method further includes identifying, by the fraud detection and prevention system, the at least one avatar as a suspicious avatar operated by an unauthorized human participant different from the authorized human participant in response to the at least one real-time behavior being different from at least one expected behavior of the at least one avatar.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a system for providing fraud detection and prevention in a VR collaboration environment in accordance with one or more embodiments of the present disclosure;

FIG. 3 depicts a VR collaboration environment including a plurality of virtual participants monitored by a VR collaboration fraud detection system in accordance with one or more embodiments of the present disclosure; and

FIG. 4 depicts the predicted behavior virtual participant determined by the VR collaboration fraud detection system in accordance with one or more embodiments of the present disclosure;

FIG. 5 depicts a suspected unauthorized virtual participant identified by the VR collaboration fraud detection system in accordance with one or more embodiments of the present disclosure;

FIG. 6 is a block diagram illustrating a VR collaboration fraud detection system in accordance with one or more embodiments of the present disclosure; and

FIG. 7 is a block diagram illustrating operations for training a VR collaboration fraud detection system in accordance with one or more embodiments of the present disclosure.

### DETAILED DESCRIPTION

The concept of the VR environment or “metaverse” has gained significant attention and interest in recent years, especially as technology advances and more companies invest in virtual reality, augmented reality, and related technologies. It is seen as a potential next step in the evolution of the internet where the physical and digital worlds become increasingly integrated together and new forms of social interaction, entertainment, and commerce emerge.

As described above, the VR environment allows users to simultaneously interact with each other and digital objects in real-time, regardless of their physical location. Businesses and enterprises have started to incorporate VR environments into their operations in various manners such as conducting business meetings, hosting virtual conferences and social events, and using the VR environment as a training platform conduct training sessions. For instance, a business enterprise may establish a local VR collaboration environment where the participating users are represented as a virtual persona typically referred to as an “avatar. Each participant can therefore view, talk and interact with one another's avatar to collaborate and discuss business ideas, projects, and strategies.

Many organizations that have adopted VR collaboration in their business environment may not have the strong cybersecurity infrastructure or IT support to help with implementation and patching vulnerabilities. For instance, participating users are not able to view the actual human participant, so there is a huge opportunity for unauthorized humans such as hackers, for example, to restrict authorized user to enter in VR collaborative environment, and instead place themselves (i.e., disguise) as a participant of the VR collaboration without the remaining participants knowing the hacker's true identity. This allows the hacker to participate in business meetings and conversations with other participants in the VR environment to obtain confidential information.

Non-limiting embodiments include systems, methods, and computer program products for providing fraud detection and prevention in a VR collaboration environment. The VR collaboration fraud detection system and method described herein utilize the immense amount of proprietary AR/VR data and records collected by a business enterprise to establish an unfair advantage against hackers or unauthorized users attempting to participate in a VR collaboration environment. For instance, the business enterprise owns vast amount of enterprise AR/VR data and records such as emails, social media historical data, teleconference historical data, videoconference historical data, chat data, prior VR collaborations, etc. The VR collaboration fraud detection system can utilize the enterprise AR/VR data with an artificial intelligence (AI) learning model such as a natural language processing (NLP) model, for example, to learn and identify the behavior of each authorized avatar. When any user enters in any VR environment, the VR collaboration fraud detection system monitors the behaviors of the avatars as they interact in the VR environment and predicts the behaviors (e.g. phonation, pitch, loudness, rate, body language) of the participants based on their learned behaviors (e.g., learned from enterprise AR/VR data). Based on observed interactions, the VR collaboration fraud detection system can identify behaviors of an avatar that do not reflect the predicted behaviors of the avatar, and identify that avatar as a suspicious user (e.g., hacker or unauthorized human participant). The VR collaboration fraud detection system can then alert of a possible collaboration compromise and/or remove the suspicious user from the VR environment.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as monitoring a VR environment in real time and performing fraud detection and prevention based on the behaviors of avatars participating in an ongoing VR collaboration. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

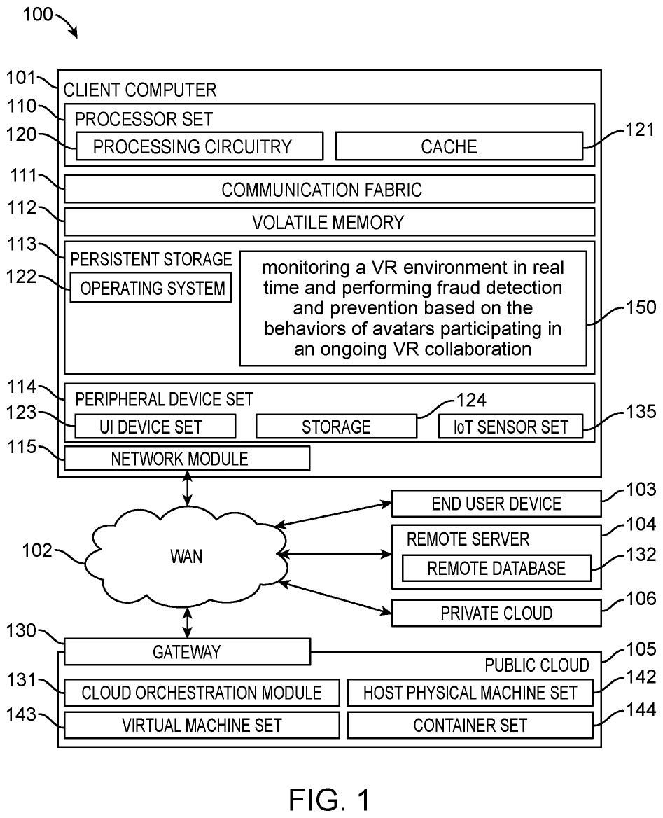

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 132, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

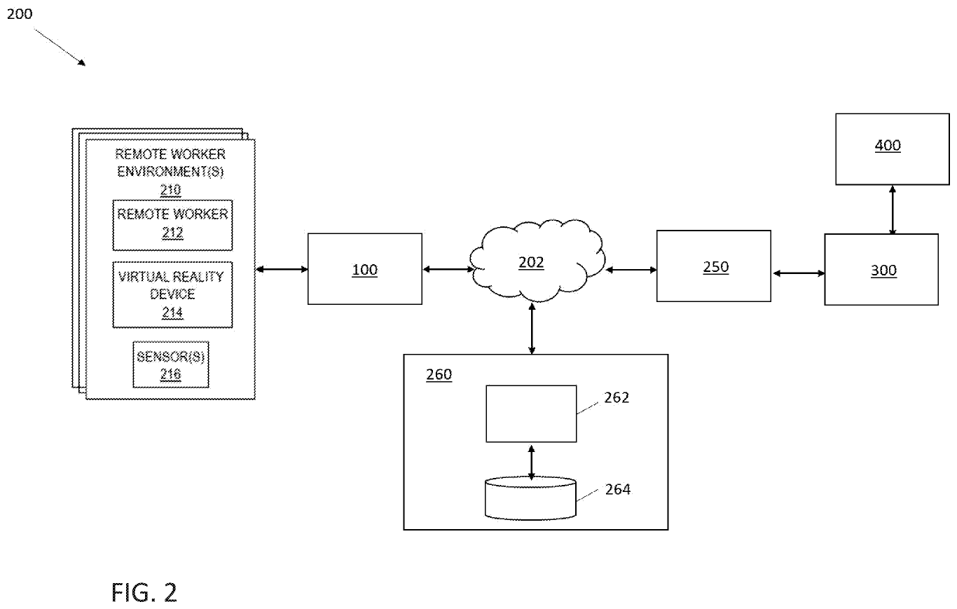

Referring now to FIG. 2, a block diagram of a virtual reality collaboration network 200 capable of providing fraud detection and prevention in a VR collaboration environment is illustrated in accordance with one or more embodiments of the present disclosure. As illustrated, the network 200 includes one or more remote worker environments 210, a computer system 100, a VR computing system 250, a business environment 260, a VR environment 300 and a fraud detection and prevention system 400. The remote worker environments 210, computer system 100, VR computing system 250, business environment 260, VR environment 300, and fraud detection and prevention system 400 can communicate and exchange data with one another via a communications network 202. The communications network 202 may include a private network, a public network such as the Internet, or a combination thereof.

The VR computing system 250 is a computing system capable of generating a VR and/or AR environment 300. The VR and/or AR environment 300 includes a computer-generated, interactive, and immersive simulation of a three-dimensional (3D) world or experience. A remote worker 212 located in their physical remote worker environment 210 can explore and interact with the VR and/or AR environment 300 using specialized hardware, such as VR devices 214 operated by the remote worker 212 and/or VR sensors 216 that monitor the remote worker 212. The VR computing system 250 can also incorporate special audio into the VR and/or AR environment 300, which allows directional sound output to the remove worker 212. The VR computing system 250 can also enrich the remote worker's virtual experience through haptic feedback devices or controllers that provide tactile sensations, allowing the remove worker 212 to interact with and feel objects within the virtual space. For example, the remote worker 212 might feel a slight vibration when touching a virtual object or a sensation of resistance when pushing against a solid surface.

In exemplary embodiments, each of the remote worker environments 210 includes a VR 214, and one or more VR sensors 216. The VR sensors 216 (e.g., image sensors, touch sensors, etc.) are configured to monitor the remote worker environment 210. In one embodiment, the VR sensors 216 are configured to measure the physical characteristics of the remote worker environment 210 and the position of the remote worker 212 within the remote worker environment 210. For example, the VR sensors 216 can measure the distance between the remote worker and walls, furniture, other people, or other objects disposed within the remote worker environment 210. In another embodiment, the sensors are configured to measure other characteristics of the remote worker environment 210. For example, the VR sensors 216 can measure a power level of the VR 214, a quality of a communications link between the VR 214 and the production device 222, and the like.

In exemplary embodiments, the virtual reality (VR) device 214 is one of a VR headset or multi-projected environment that is configured to generate realistic images, sounds, movements, and other sensations to simulate the presence of the remote worker 212 in the production environment 220. The VR device 214 is further configured to present one or more digital twins, one or more virtual participants (i.e., “avatars”) of the remove worker 212, and produce an interaction between the remote worker 212, the digital twins and/or the avatars. The VR device 214 transmits the captured interaction data between the remote worker 212 and the avatar such that the remote worker 212 is able to physically control and interact with the avatar using the VR device 214.

The business environment 260 is operated by the business enterprise associated with the remote workers 212. For instance, the remote workers 212 may be business associates and workers of the business enterprise. The business environment 260 includes an enterprise computing system 262 and an enterprise database 264. The enterprise computing system 262 can include a similar computing system 100 as described in FIG. 1. The enterprise database 264 stores various enterprise data such as, for example, enterprise worker data and historical enterprise VR/AR data. The enterprise worker data includes identification (ID) data including, but not limited to, a workers name, working department, business title, clearance level, etc. The enterprise VR/AR data includes, but is not limited to, avatar profile information, avatar appearance information, emails, social media historical data, videoconference historical data, chat history, etc.

The enterprise VR/AR data can be gathered in a variety of ways such as, for example, text recognition applied to emails, social media historical data, videoconference historical data and chat history, or recordings of teleconferences, videoconferences and/or prior VR collaborations. The text recognition can be provide language and/or text tendencies and patterns of a corresponding remote worker 212. The videoconference recordings can also provide speech tendencies and patterns, but also body movement tendencies and patterns, facial expression tendencies and patterns, and speech tendencies and patterns. The body movement tendencies can include, for example, head nodding, hand motions, and writing tendencies, e.g., based on whether the person is right handed or left handed and/or the amount a person uses the right hand to perform a motion (e.g., raises their hand) compared to their left hand and vice versa. The speech tendencies and patterns can also provide tendencies and patterns associated with how a person speaks such as their phonation, pitch, loudness, and speaking/speech rate. The videoconference recordings can also indicate how often a remote worker 212 typically involves themselves in conversations and the level of knowledge and/or viewpoint they typically have regarding a particular subject.

The VR computing system 250 is configured to generate the VR environment 300 based on the enterprise data provided by the business environment 260. For example, the VR computing system 250 can generate a virtual collaboration environment 300 represented by a virtual conference room, for example, and place avatars for each remote worker 212 wishing to participate in the virtual collaboration environment 300. The avatars are then generated using the enterprise data stored in the enterprise database 264. Accordingly, avatars appear in the virtual collaboration environment 300 and can be identified by their corresponding enterprise work data (e.g., name, business title, etc.) and enterprise VR/AR data (e.g., avatar appearance).

The VR collaboration fraud detection system 400 monitors the VR environment 300 and behaviors of the avatars as they interact in the VR environment 300. As described herein, the VR collaboration fraud detection system 400 is trained to learn expected behaviors (e.g. expressions, phonation, pitch, loudness, rate, body language, etc.) of the avatars representing a remote worker 212 or virtual participant based on the enterprise AR/VR data and then predict the behaviors of the avatars participating in the VR environment 300. Based on observed interactions and behaviors of the avatars, the VR collaboration fraud detection system 400 can identify behaviors of a particular avatar that do not reflect the predicted behaviors of the avatar, and identify that avatar as being associated with a suspicious user (e.g., hacker, someone falsely posing as an authorized remote worker, and/or another unauthorized participant). The VR collaboration fraud detection system 400 can then alert of a possible collaboration compromise and/or remove the suspicious user from the VR environment 300 and/or from the entire network 200.

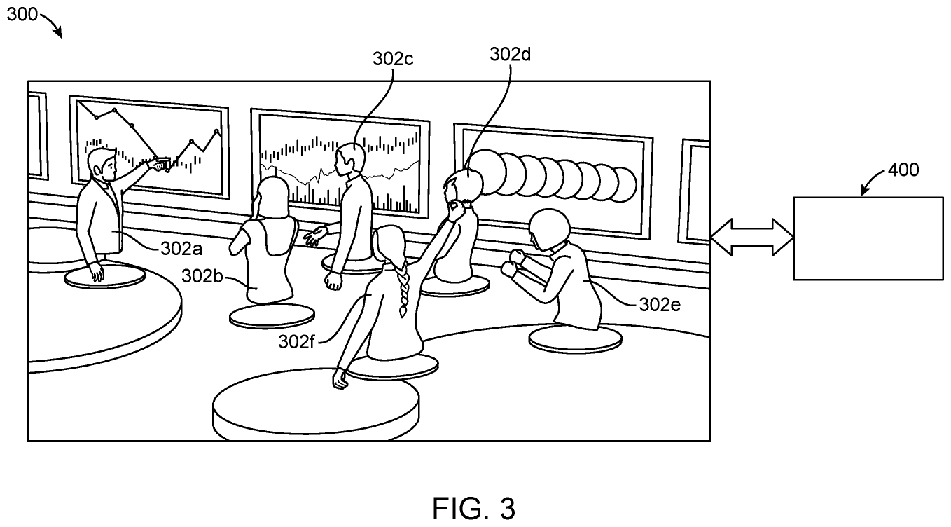

Referring now to FIG. 3, a VR collaboration environment 300 including a plurality of virtual participants 302a, 302b, 302c, 302d, 302e and 302f (collectively referred to virtual participants 302a-302f) that are monitored by a VR collaboration fraud detection system 400 is illustrated according to a non-limiting embodiment of the present disclosure. Each virtual participant 302a-302f (i.e., avatars 302a-302f) represents a real life human located a physical environment, but who is collaborating in real-time with other humans via interaction between the VR environment 300 and the other avatars 302a-302f. The real life human can include a remote worker 212 of a business enterprise running the VR collaboration environment 300, or can be real-life human that is not necessarily an employee of the business enterprise but that is participating in the VR environment 300. While participating in the VR environment 300, the avatars 302a-302f can collaborate with one another in response to spoken language and/or movements of a respective real life human in their physical environment (e.g., remote worker environment 210). Each of the avatars 302a-302f are intended to be authorized participants of the VR environment 300 and thus are expected to represent a real life human that is authorized to participate in the VR collaboration.

The VR collaboration fraud detection system 400 monitors the VR environment 300 and the behaviors of the avatars 302a-302f. For instance, the collaboration fraud detection system 400 can monitor the movements of the avatars 302a-302f, the conversations of participants in the VR collaboration and/or chat streams that may be ongoing during the VR collaboration. In this example, an engaged avatar 302f raises their right arm to gain attention, which is detected by the VR collaboration fraud detection system 400.

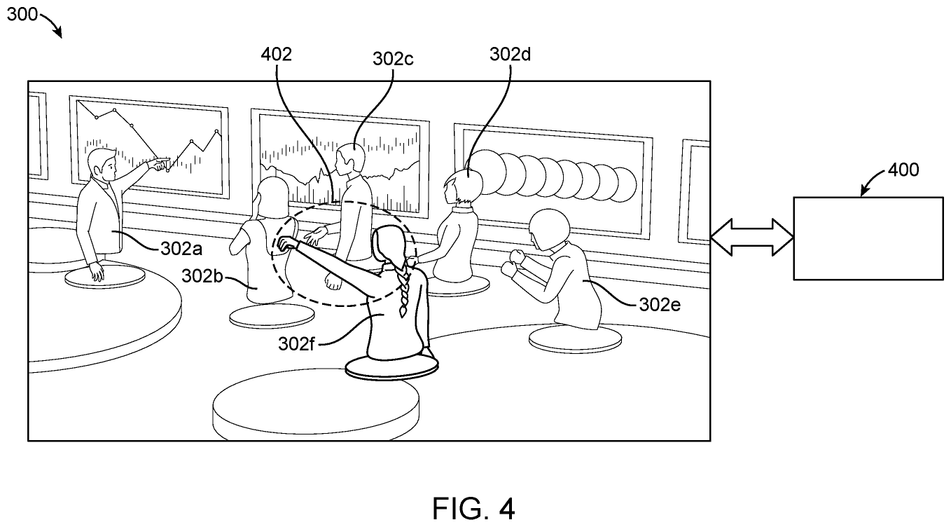

Turning to FIG. 4, the VR collaboration fraud detection system 400 can compare the real time motion (e.g., engaged avatar 302f raising their hand) of the avatar to an expected motion 402 learned by the VR collaboration fraud detection system 400 through AI training that utilizes the corresponding real life human's collected enterprise VR/AR data. In this example, the VR collaboration fraud detection system 400 identifies that that the engaged avatar 302f raises their right arm (see FIG. 3), but determines that that real life human associated with the engaged avatar 302f is left handed and almost never raises their right hand to gain attention. Rather based on the collected enterprise VR/AR data (e.g., previous recordings of teleconferences and prior VR collaborations) involving the real life human associated with the engaged avatar 302f would raise their left hand the majority of time.

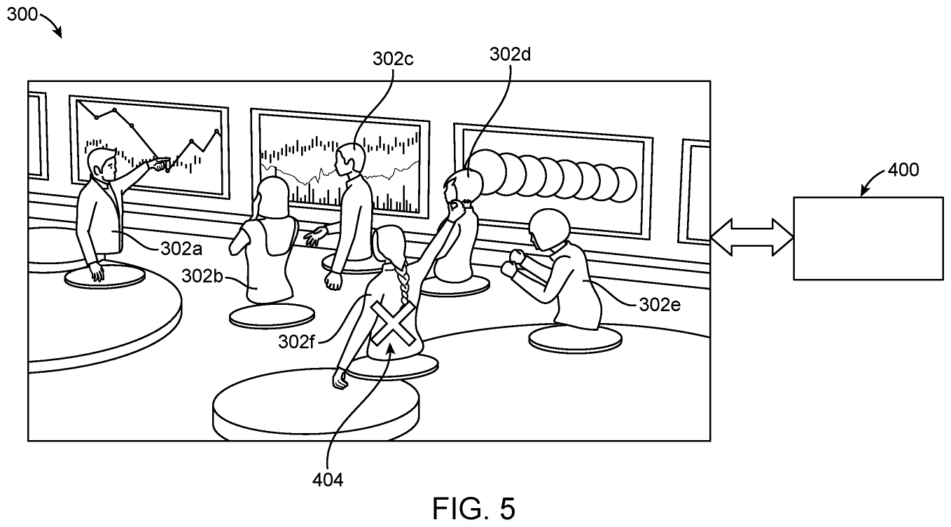

Turning to FIG. 5, the VR collaboration fraud detection system 400 identifies the engaged avatar 302f as a suspicious avatar 404 being associated with a suspicious user 404. In one or more non-limiting embodiments, the VR collaboration fraud detection system 400 can continue monitoring the suspicious avatar 404 to determine whether additional behaviors fail to reflect the expected behaviors of the corresponding authorized real life human. For example, the VR collaboration fraud detection system 400 can compare real-time speech characteristics (e.g. phonation, vocal pitch, vocal loudness, and/or speech/speaking rate) to expected speech characteristics of the expected human participant corresponding to the user profile of the suspicious avatar 404 to further determine whether the suspicious avatar 404 is an unauthorized participant of the ongoing VR collaboration.

In one or more non-limiting embodiments, the VR collaboration fraud detection system 400 can monitor the suspicious avatar 404 over a time period and then generate a similarity score based on the suspicious avatar's behavior, movements and/or speech over the time period. When the similarity score fails to reach a score threshold, the VR collaboration fraud detection system 400 can generate an alert indicating the suspicious avatar 402 is under the control of an unauthorized participant (e.g., a hacker). Accordingly, the VR collaboration fraud detection system 400 can remove the suspicious avatar 402 and corresponding network connection (e.g., the remote worker environment 210 associated with the suspicious avatar 402) from the VR environment 300 and/or from the entire network 200.

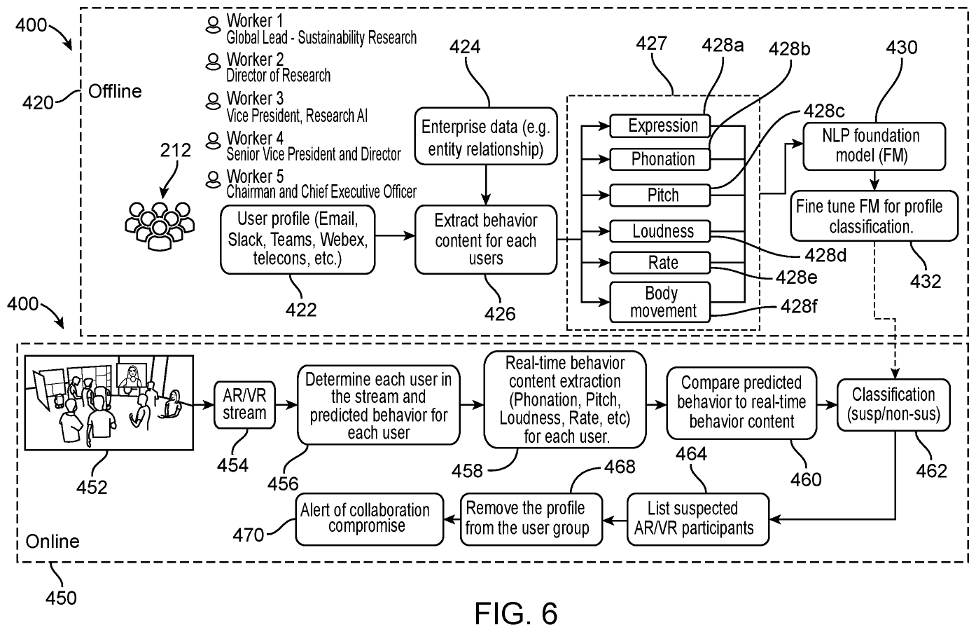

With reference now to FIG. 6, a VR collaboration fraud detection system 400 is illustrated according to a non-limiting embodiment of the present disclosure. The VR collaboration fraud detection system 400 is illustrated operating in an offline environment 420 and an online environment 450. The offline environment 420 is used to perform AI training so that the fraud detection and prevention can learn the behaviors of real life humans that can participate in the VR environment 300. Once trained, the VR collaboration fraud detection system 400 can operate in the online environment 450 to perform fraud detection and prevention in a VR collaboration environment 300.

Turning first to the offline environment 420, the VR collaboration fraud detection system 400 receives enterprise VR/AR data at operation 422 and enterprise worker data at operation 424. Each of the VR/AR data and the worker data corresponds to a particular real life human 212 (e.g., a remote worker 212) that can participate in a VR collaboration environment generated by the business entity. The enterprise VR/AR data 422 includes, but is not limited to, a user profile, avatar profile information, avatar appearance information, emails, social media historical data, videoconference historical data, chat history, etc. The enterprise worker data 424 includes information indicating how a given user profile is associated or related to the business entity. The enterprise worker data 424 includes identification (ID) data including, but not limited to, a workers name, working department, business title, clearance level, etc.

At operation 426, the VR collaboration fraud detection system 400 performs a behavior extraction operation that extracts behavior information associated with a given real life human 212 based on the real life human's corresponding VR/AR data and enterprise worker data. The resulting behavior extraction generates expected behavior information 427 for the respective real life human 212. The expected behavior information 427 includes, but is not limited to, expression data 428a, phonation data 428b, speech pitch data 428c, speech loudness data 428d, speech/speaking rate data 428e, and body movement data 428f.

The expected behavior information 427 is then input to a machine learning foundation model (FM) at operation 430. The FM model can include a natural language processing (NLP) FM model, which is trained on several iterations of the extracted expected behavior information 427 corresponding real life human 212 to learn and process human language, movements, tendencies and behaviors. In one or more non-limiting embodiments the FM model can be fined tuned at operation 432. The fine-tuning can involve adjusting various model parameters to optimize its performance on the user profile domain. The Fine-tuning can involve several steps, such as preparing the extracted expected behavior information 427 by splitting it into training, validation, and test sets and preprocessing them according to the model's requirements.

After the FM training is complete, the fraud detection and prevention system 400 can operate in the online environment 450 to monitor a VR environment 300 in real time and utilize the trained FM model to perform fraud detection and prevention based on the behaviors of avatars participating in an ongoing VR collaboration. At operation 452, a VR environment 300 is generated (e.g., by VR computing system 250) and a live stream of the VR environment 300 (e.g., a stream of real-time images of the VR environment and the interacting avatars) is monitored by the fraud detection and prevention system 400 at operation 454. At operation 456, the fraud detection and prevention system 400 identifies each avatar participating in the VR environment, determines the expected human participant associated with a given avatar based on the corresponding user profile, and determines the expected or predicted behaviors of the identified avatars based on the trained FM.

At operation 458, the fraud detection and prevention system 400 extracts real-time behaviors of the avatars participating in the VR environment. The extracted real-time avatar behaviors include, but are not limited to, expressions, phonation, vocal pitch, vocal loudness, speech/speaking rate, vocabulary, body language, body movement, predicted vocal response, predicted body responses, personal tendencies, etc. At operation 460, the fraud detection and prevention system 400 compares the extracted real-time avatar behaviors to the expected or predicted avatar behaviors and determines whether a given avatar is authentic (i.e., not suspicious) or suspicious at operation 462. In one or more non-limiting embodiments, the fraud detection and prevention system 400 can calculate similarity score for each avatar. Avatars with similarity scores that are equal to or greater than a score threshold are identified as authentic (i.e., not suspicious), while avatars with similarity scores that are less than the score threshold are identified as suspicious. In another non-limiting embodiment, the fraud detection and prevention system 400 can count a number of differences between the real-time behavior of a given avatar and its expected or predicted behavior. When the number of differences exceeds a count threshold, the fraud detection and prevention system 400 can identify the avatar as a suspicious avatar.

At operation 464 the suspicious user profiles of any suspicious avatar is listed and/or an alert is generated indicating a suspicious avatar is a possible unauthorized participant of the VR environment 300. In one or more non-limiting embodiments, the human participant associated with user profile of a suspicious avatar may be requested to turn on their camera and show their actual face in order to authenticate their identify. In one or more non-limiting embodiments, the human participant associated with user profile of a suspicious avatar may be sent a code to a private email address or electronic device and asked to input the code to authenticate their identify. When the human participant associated with user profile of a suspicious avatar fails to authenticate their identify, the fraud detection and prevention system 400 can remove the suspicious user from the VR environment 300 and/or from the entire network 200, and alert of a possible collaboration compromise at operation 470.

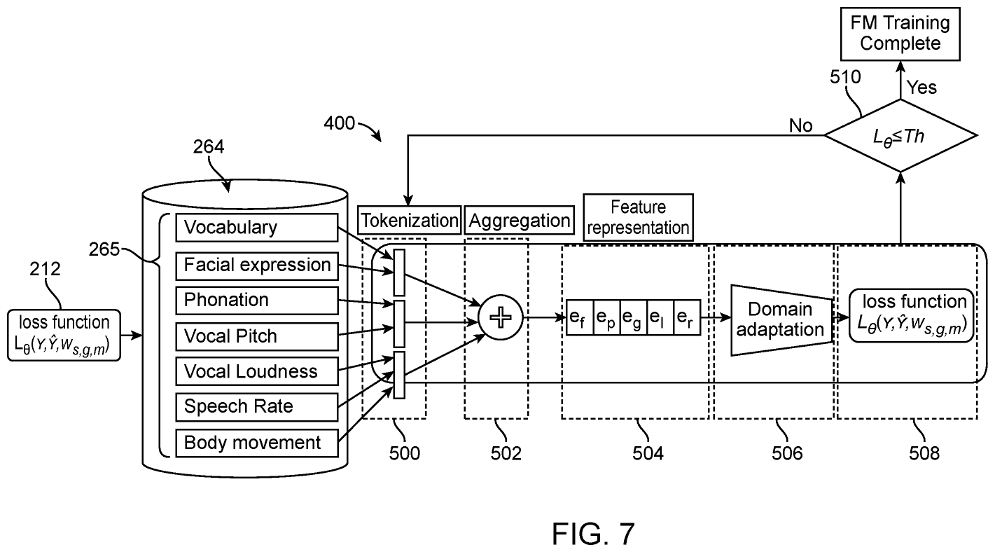

Turning now to FIG. 7, operations for training a VR collaboration fraud detection system 400 is illustrated in accordance with one or more embodiments of the present disclosure. The VR collaboration fraud detection system 400 receives enterprise VR/AR data 265 corresponding to a real life human 212 (e.g., a remote worker 212). The enterprise VR/AR data 265 is collected by a business enterprise and stored in an enterprise database 264. As described herein, the enterprise VR/AR data 265 includes, but is not limited to, vocabulary, facial expressions, phonation, vocal pitch, vocal loudness, speech rate, and body language. A tokenization operation is performed on the input enterprise VR/AR data 265 at training stage 500. The tokenization operation includes applying one or more tokenization techniques to the enterprise VR/AR data 265. In a non-limiting embodiment, vocal and speech data can be converted into text (e.g. by applying speech transcription to vocal recordings) and applying one or more tokenization techniques to the text. The tokenization techniques can include, but are not limited to, word tokenization, subword tokenization, character tokenization. Accordingly, the tokenization operation divides the converted text enterprise VR/AR data into smaller units called tokens of individual words, subwords, or characters, depending on the tokenization operation performed. In a non-limiting embodiment, the tokenization techniques include “pose estimation” and/or “joint detection,” which segments human body movements into smaller units or key points, analogous to “tokens”.

The tokens generated by the tokenization training stage 500 are then aggregated according to an aggregation training stage 502. According to a non-limiting embodiment, the aggregation training stage 502 includes converting the tokens into dense vector representations (e.g. raw data) called embeddings to produce a source domain. These embeddings capture the context and meaning of each token. A feature representation training stage 504 is then performed to transform the embeddings (e.g., raw data) into a format that can be input to a FM. The feature representation training stage 504 can include, for example, performing data pre-processing (e.g., cleaning, normalization, and handling missing values of the embeddings), feature selection (e.g., choosing a subset of the most relevant features that have the most impact on the model's performance), feature extraction (s transforming raw data into a set of more meaningful and compact representations), feature transformation (e.g., log-transformations, power transformations, and z-score normalization), encoding categorical variables (e.g., encoding variables into a numerical format that can be input to a FM), and feature representation learning (e.g., unsupervised or autoencoder representation learning directly from embeddings).

A domain adaptation training stage 506 utilizes information provided by the source domain to improve the robustness of an FM and make it more capable of generalizing the source domain to a target domain. The domain adaptation training stage 506 may include, but is not limited to, feature-based adaptation, instance-based adaptation, model-based adaptation, self-supervised learning, and unsupervised learning.

An AI loss function (L_{θ}) (sometimes referred to as a “cost function”) is calculated at training stage 508. The loss function measures the discrepancy between the predicted output of a FM and the actual target output (e.g., the ground truth) during training. The loss function quantifies how well the model is performing and can be used to guide the training fine tuning process to minimize the error or loss. Various loss functions can be used including, but not limited to, a regression loss function, a classification loss function, a sequence-to-sequence loss function, and a custom loss function.

During the training process, the fraud detection and prevention system 400 can iteratively adjust the parameters of a FM to minimize the value of the loss function. Lower values of the loss function indicate better alignment between the model's predictions and the true targets, which corresponds to an improved performance of the model on a targeted task. According to a non-limiting embodiment, the calculated loss function (L_{θ}) is compared to a target threshold (Th) at training stage 510. When the loss function (L_{θ}) is exceeds the threshold (Th), the FM parameters can be adjusted and the FM re-trained via training stages 500 through 508. Once the loss function (L_{θ}) is below or equal to the threshold (Th), training of the FM can be completed and the trained FM can be utilized by the fraud detection and prevention system 400 (e.g., in the online environment 450) to monitor a VR environment 300 in real time and perform fraud detection and prevention based on the behaviors of avatars participating in an ongoing VR collaboration.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A virtual reality (VR) collaboration network comprising:
a VR computing system configured to generate a VR environment and to generate at least one avatar within the VR environment based on a user profile associated with an authorized human participant; and
a fraud detection and prevention system configured to monitor the VR environment and at least one real-time behavior of the at least one avatar, and to identify the at least one avatar as a suspicious avatar operated by an unauthorized human participant different from the authorized human participant in response to the at least one real-time behavior being different from at least one expected behavior of the at least one avatar.

2. The VR collaboration network of claim 1, wherein the fraud detection and prevention system is trained to learn the at least one expected behavior of the at least one avatar based on historical enterprise VR/AR data corresponding to the authorized human participant.

3. The VR collaboration network of claim 2, wherein the fraud detection and prevention system implements an artificial intelligence (AI) model that is trained to learn the at least one expected behavior using the historical enterprise VR/AR data.

4. The VR collaboration network of claim 3, wherein the fraud detection and prevention system inputs at least one image of the at least one real-time behavior into the trained AI model to determine the at least one expected behavior of the at least one avatar, and compares the at least one expected behavior to the at least one real-time behavior to determine whether the at least one avatar is operated by one of the authorized human participant or the unauthorized human participant.

5. The VR collaboration network of claim 4, wherein the fraud detection and prevention system removes the suspicious avatar from the VR environment in response to determining the unauthorized human participant.

6. The VR collaboration network of claim 5, wherein the fraud detection and prevention system generates an alert that the VR collaboration network has been compromised in response to determining the unauthorized human participant.

7. The VR collaboration network of claim 1, wherein the at least one real-time behavior includes one or a combination of vocabulary, phonation, vocal pitch, vocal loudness, speech rate, body expression, and body movement, and
wherein the historical enterprise VR/AR data includes one or a combination of emails, social media historical data, teleconference historical data, videoconference historical data, chat data, and prior VR collaborations.

8. A method of performing fraud detection and prevention in a virtual reality (VR) collaboration environment, the method comprising:
generating, by a VR computing system, a VR environment;
generating, by the VR computing system, at least one avatar within the VR environment based on a user profile associated with an authorized human participant;
monitoring, by a fraud detection and prevention system, the VR environment and at least one real-time behavior of the at least one avatar; and
identifying, by the fraud detection and prevention system, the at least one avatar as a suspicious avatar operated by an unauthorized human participant different from the authorized human participant in response to the at least one real-time behavior being different from at least one expected behavior of the at least one avatar.

9. The method of claim 8, further comprising training the fraud detection and prevention system to learn the at least one expected behavior of the at least one avatar based on historical enterprise VR/AR data corresponding to the authorized human participant.

10. The method of claim 9, wherein training the fraud detection and prevention system includes training an artificial intelligence (AI) model to learn the at least one expected behavior using the historical enterprise VR/AR data.

11. The method of claim 10, wherein monitoring the at least one real-time behavior of the at least one avatar includes:
inputting at least one image of the at least one real-time behavior into the trained AI model to determine the at least one expected behavior of the at least one avatar; and
comparing the at least one expected behavior to the at least one real-time behavior to determine whether the at least one avatar is operated by one of the authorized human participant or the unauthorized human participant.

12. The method of claim 11, further comprising removing, by the fraud detection and prevention system, the suspicious avatar from the VR environment in response to determining the unauthorized human participant.

13. The method of claim 12, further comprising generating an alert by the fraud detection and prevention system to indicate that the VR collaboration network has been compromised in response to determining the unauthorized human participant.

14. The method of claim 8, wherein the at least one real-time behavior includes one or a combination of vocabulary, phonation, vocal pitch, vocal loudness, speech rate, body expression, and body movement, and
wherein the historical enterprise VR/AR data includes one or a combination of emails, social media historical data, teleconference historical data, videoconference historical data, chat data, and prior VR collaborations.

15. A computer program product comprising a computer readable storage medium having program instructions embodied therewith to perform fraud detection and prevention in a virtual reality (VR) collaboration environment, the program instructions executable by a processor to cause the processor to perform operations comprising:
generating, by a VR computing system, a VR environment;
generating, by the VR computing system, at least one avatar within the VR environment based on a user profile associated with an authorized human participant;
monitoring, by a fraud detection and prevention system, the VR environment and at least one real-time behavior of the at least one avatar; and
identifying, by the fraud detection and prevention system, the at least one avatar as a suspicious avatar operated by an unauthorized human participant different from the authorized human participant in response to the at least one real-time behavior being different from at least one expected behavior of the at least one avatar.

16. The computer program product of claim 15, wherein the instructions further comprise training the fraud detection and prevention system to learn the at least one expected behavior of the at least one avatar based on historical enterprise VR/AR data corresponding to the authorized human participant.

17. The computer program product of claim 16, wherein training the fraud detection and prevention system includes training an artificial intelligence (AI) model to learn the at least one expected behavior using the historical enterprise VR/AR data.

18. The computer program product of claim 17, wherein monitoring the at least one real-time behavior of the at least one avatar includes:
inputting at least one image of the at least one real-time behavior into the trained AI model to determine the at least one expected behavior of the at least one avatar; and
comparing the at least one expected behavior to the at least one real-time behavior to determine whether the at least one avatar is operated by one of the authorized human participant or the unauthorized human participant,
wherein the at least one real-time behavior includes one or a combination of vocabulary, phonation, vocal pitch, vocal loudness, speech rate, body expression, and body movement, and
wherein the historical enterprise VR/AR data includes one or a combination of emails, social media historical data, teleconference historical data, videoconference historical data, chat data, and prior VR collaborations.

19. The computer program product of claim 18, wherein the instructions further comprise removing, by the fraud detection and prevention system, the suspicious avatar from the VR environment in response to determining the unauthorized human participant.

20. The computer program product of claim 19, wherein the instructions further comprise generating an alert by the fraud detection and prevention system to indicate that the VR collaboration network has been compromised in response to determining the unauthorized human participant.
